(19) United States
(12) Patent Application Publication
(10) Pub. No.: US 2024/0049648 A1
(43) Pub. Date: Feb. 15, 2024

(54) Telescoping Fruit Pruning Device and a Method of Use Thereof

(71) Applicant: Jordan Sabado, San Jose, CA (US)

(72) Inventor: Jordan Sabado, San Jose, CA (US)

(21) Appl. No.: 18/154,902

(22) Filed: Jan. 16, 2023

Related U.S. Application Data
(60) Provisional application No. 63/396,992, filed on Aug. 11, 2022.

(51) Int. Cl. A01G 3/033; A01G 3/037

(52) U.S. Cl. CPC A01G 3/0335; A01G 3/037; A01G 2003/023

(57) ABSTRACT

The present invention relates to a fruit pruning and collecting device. The device features a telescoping pole having a basket at the top end and an ergonomic grip at the bottom end. The pole has a plurality of telescoping sections for adjusting a length of the pole and enabling a user to reach elevated fruits without climbing on a ladder. The basket has pruning blades that are actuated by a manual trigger or an electric power button for pruning a stem positioned between the blades to remove one or more fruits. The basket does not allow the fruits to drop onto ground. In use, the device is positioned with the basket under the fruits on the tree with the stem in between the blades such that the blades when actuated prune the stem and enable the fruit to fall into the basket.

### CROSS-REFERENCE TO RELATED APPLICATION

The present application claims priority to, and the benefit of, U.S. Provisional Application No. 63/396,992, which was filed on Aug. 11, 2022, and is incorporated herein by reference in its entirety.

### FIELD OF THE INVENTION

The present invention relates generally to the field of fruit pruning device. More specifically, the present invention relates to a novel device for collecting fruits from trees via a pruning blade and collection basket. The device includes a telescoping pole enabling users to reach elevated fruits without climbing onto a ladder or using any other similar device. A trigger or a power button actuates the blade to prune a stem of a fruit to remove the fruit from trees wherein the fruit is then dropped into the basket for safe storage. Accordingly, the present disclosure makes specific reference thereto. Nonetheless, it is to be appreciated that aspects of the present invention are also equally applicable to other like applications, devices, and methods of manufacture.

### BACKGROUND

By way of background, fruit tree pruning is the cutting and removing of selected parts of a fruit tree. Harvesting or pruning fruits is the operation of gathering the fruits of a tree and is carried out at the time when all the nutrients have developed, and the edible parts have reached the appropriate degree of maturity. Generally, fruit picking or harvesting ladders are used by individuals in order to climb to reach elevated branches for collecting fruits. Individuals may shake the branches after climbing the ladder to collect the fruits. However, such ladders are not secure and unstable as they are placed on uneven surfaces. As a result, individuals fall off the ladder which can result in an injury. Many times, fruits fall from a branch of a tree during the harvesting or pruning process and can be easily damaged.

A lot of individuals use bamboo sticks or other elongated items to shake tree branches for enabling the fruits to fall from the branches. However, such sticks are ineffective and a lot of force may be applied by a user to shake branches to collect the fruits. Even hand clippers are ineffective in pruning fruits as the fruits drop directly onto the ground, which can easily damage them.

All the conventional means of collecting fruits from fruit trees typically require a user to shake the branches, which may break the branches and results in fruits being dropped onto the ground. Currently, harvesting fruits and vegetables from elevated branches require extensive effort and time. Elderly and physically weak individuals find it almost impossible to prune and harvest fruits from trees. Individuals desire an improved device that allows users to reach elevated branches easily and safely enabling them to remove fruits without damaging the fruits and the branches.

Therefore, there exists a long-felt need in the art for a device that allows users to easily collect fruits from trees. There is also a long-felt need in the art for a fruit harvesting device that allows individuals to easily reach elevated branches of a fruit tree without using ladders. Additionally, there is a long-felt need in the art for a fruit pruner device that obviates the need for users to stand on a ladder to collect the fruits. Moreover, there is a long-felt need in the art for a specialized device that obviates dropping of the fruits onto the ground from branches during the process of pruning or harvesting. Further, there is a long-felt need in the art for a handheld device that allows users to remove fruits from trees without damaging the tree. Furthermore, there is a long-felt need in the art for a device that obviates shaking of branches and stems for collecting fruits. There is a long-felt need in the art for a fruit harvesting device that can be used by individuals of all ages and genders. Finally, there is a long-felt need in the art for a device that saves extensive time and effort when manually picking fruits while also preventing potential injuries to users.

The subject matter disclosed and claimed herein, in one embodiment thereof, comprises a selectively extendable and retractable fruit pruning device. The fruit pruning device is a specialized device for removing and collecting fruits from trees using pruning blades and a basket. The device has a telescoping pole having a basket at a top end and an ergonomic grip at a bottom end thereof. The pole has a power button coupled to a battery for actuating pruning blades using an actuator wherein the pruning blades are horizontally positioned on the top edge of the basket. The blades are used for pruning the stems of fruits for removing fruits wherein the fruits are dropped in the basket. For reaching the elevated fruits on a tree, the pole is extended using a plurality of telescoping sections or pins disposed thereon enabling the user to reach fruits while standing on the ground.

In this manner, the telescoping fruit pruner basket device of the present invention accomplishes all of the forgoing objectives and provides users with a specialized device for collecting fruit from trees via a pruning blade and collection basket. The blade cuts the stems of fruits and the basket collects the fruits thereby preventing shaking of branches and dropping of fruits onto the ground. The telescoping pole allows users to reach elevated fruit while standing safely on the ground thereby eliminating use of ladders and ineffective pruning tools.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fruit picking device. The fruit picking device is a specialized device for collecting fruits from trees using pruning blades and a basket. The device has a telescoping pole having a basket at one end and an ergonomic grip at a second end thereof. The pole has a power button coupled to a battery for activating or actuating pruning blades, wherein the pruning blades are positioned on the top edge of the basket. The blades are used for pruning or removing fruits wherein the fruits pruned by the blades are dropped into the basket. For reaching the elevated fruits on a tree, the pole is extended using a plurality of telescoping sections or pins disposed thereon enabling the user to reach elevated fruits while standing on the ground.

In yet another embodiment, the pruning blades are horizontally oriented inside the basket such that a stem of a fruit is positioned between the blades wherein the blades are pulled towards each other to prune the stem and thereby enable the fruit to fall into the basket.

In yet another embodiment, the pole has a trigger disposed thereon and the trigger is coupled to a cable and lever system for enabling a user to press the trigger to open and close the pruning blades to prune a stem and drop fruits in the basket.

In yet another embodiment, a specialized device for collecting fruits from trees is disclosed. The device features a telescopic and adjustable pole connected to an ergonomic handle at the bottom end and a basket at the top end, a pair of sharp pruning blades within the basket along a top edge of the basket, the blades are actuated via a trigger or a power button positioned near the bottom end of the pole wherein the blades are used for pruning a stem associated with a fruit for dropping the fruit in the basket. The telescoping pole obviates the need for a user to stand on a ladder or shake branches to try and remove fruit from a tree.

In yet another embodiment, a method for safely removing fruits from a tree is described. The method includes the steps of providing a fruit pruning device, the device includes a telescoping pole, a basket having pruning blades for pruning a stem of a fruit to remove the fruit, the basket is configured to store the removed fruits, a blade operating means for operating the blades for pruning the stem; extending a length of the pole to a desired length; activating the blade operating means; pruning the stem of a fruit; accommodating the removed fruit in the basket and retracting the extended length of the pole.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a telescoping fruit pruning or removing basket device of the present invention in accordance with the disclosed architecture;

FIG. 2 illustrates a perspective view showing a user using the fruit removing device of the present invention for pruning fruits in accordance with the disclosed architecture;

FIG. 3 illustrates a functional block diagram showing the operation of the pruning blades of the pruning device of the present invention in accordance with the disclosed architecture;

FIG. 4A illustrates an enlarged view of the blades in a closed position for pruning fruits in accordance with the disclosed architecture;

FIG. 4B illustrates an enlarged view of the blades in an open position in accordance with the disclosed architecture;

FIG. 4C illustrates an enlarged view of another embodiment of a pruning device with the blades in a partially open position, and a cutting angle adjuster, in accordance with the disclosed architecture; and

FIG. 5 illustrates a flow diagram illustrating steps performed to use the extendable fruit removing device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that allows users to easily collect fruits from trees. There is also a long-felt need in the art for a fruit harvesting device that allows individuals to easily reach elevated branches of a fruit tree without using ladders. Additionally, there is a long-felt need in the art for a fruit pruner device that obviates the need for users to stand on a ladder to collect the fruits. Moreover, there is a long-felt need in the art for a specialized device that obviates dropping of the fruits onto the ground from branches during the process of pruning or harvesting. Further, there is a long-felt need in the art for a handheld device that allows users to remove fruits from trees without damaging the tree. Furthermore, there is a long-felt need in the art for a device that obviates shaking of branches and stems for collecting fruits. There is a long-felt need in the art for a fruit harvesting device that can be used by individuals of all ages and genders. Finally, there is a long-felt need in the art for a device that saves extensive time and effort when manually picking fruits while also preventing potential injuries to users.

The present invention, in one exemplary embodiment, is a method for safely removing and collecting fruits from a tree. The method includes the steps of providing a fruit pruning device, the device includes a telescoping pole, a basket having pruning blades for pruning stems of fruits to remove the fruit, the basket is configured to store the removed fruits, a blade operating means for operating the blades for pruning the stems; extending a length of the pole to a desired length; activating or actuating the blade operating means; pruning the stem of a fruit; accommodating the removed fruit in the basket and retracting the extended length of the pole.

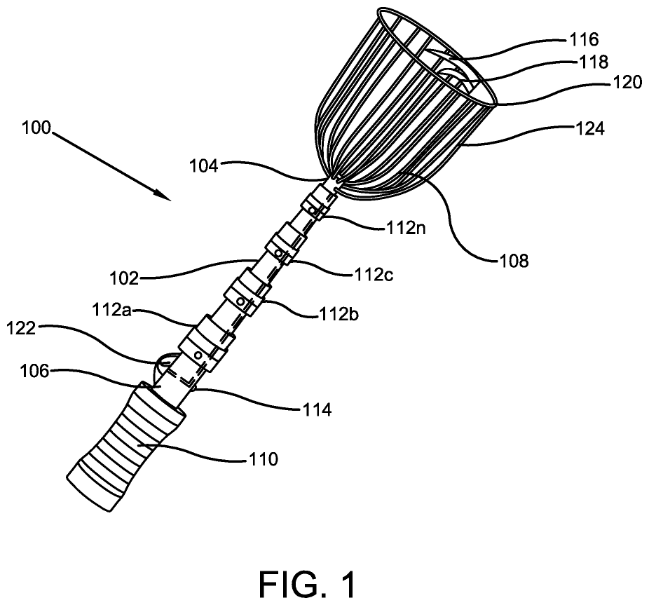

Referring initially to the drawings, FIG. 1 illustrates a perspective view of one potential embodiment of a telescoping fruit pruning basket device of the present invention in accordance with the disclosed architecture. The telescoping fruit pruning basket device 100 of the present embodiment is designed as a specialized device for effectively reaching, pruning, and collecting fruit from trees like persimmons, apples, and more. The device 100 is lightweight and telescoping that allows users to reach elevated fruits on a tree while standing safely on the ground. More specifically, the pruning device 100 includes a telescopic pole 102 having a top end 104 and a bottom end 106. The top end 104 has a fruit collecting basket 108 attached thereto for collecting the removed fruits from a tree. The basket 108 is made of a durable and lightweight material such as stainless steel or plastic and is integrally attached to the top end 104.

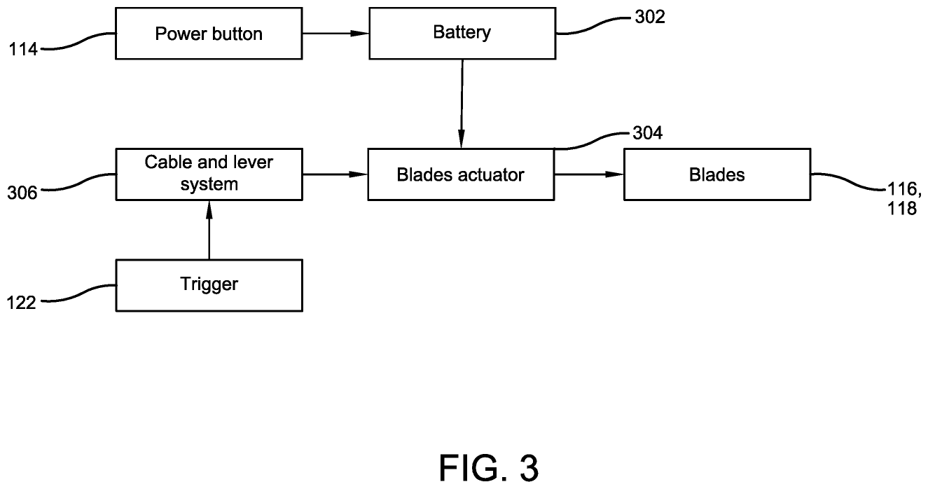

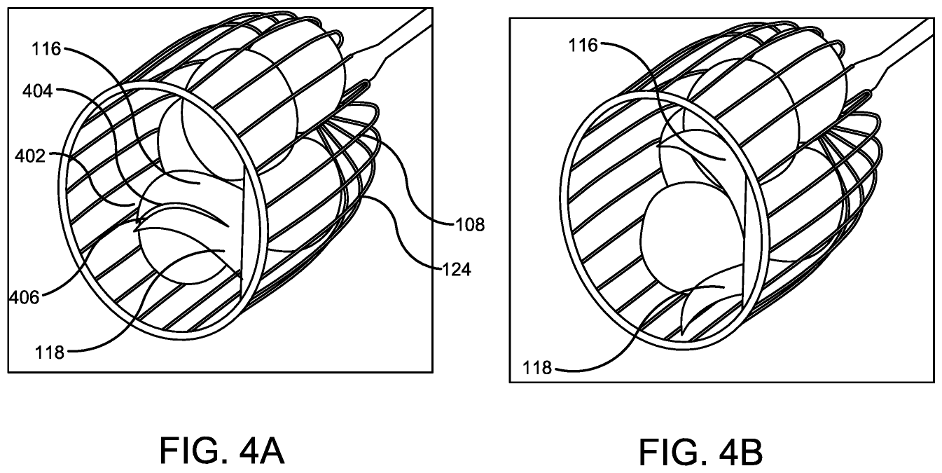

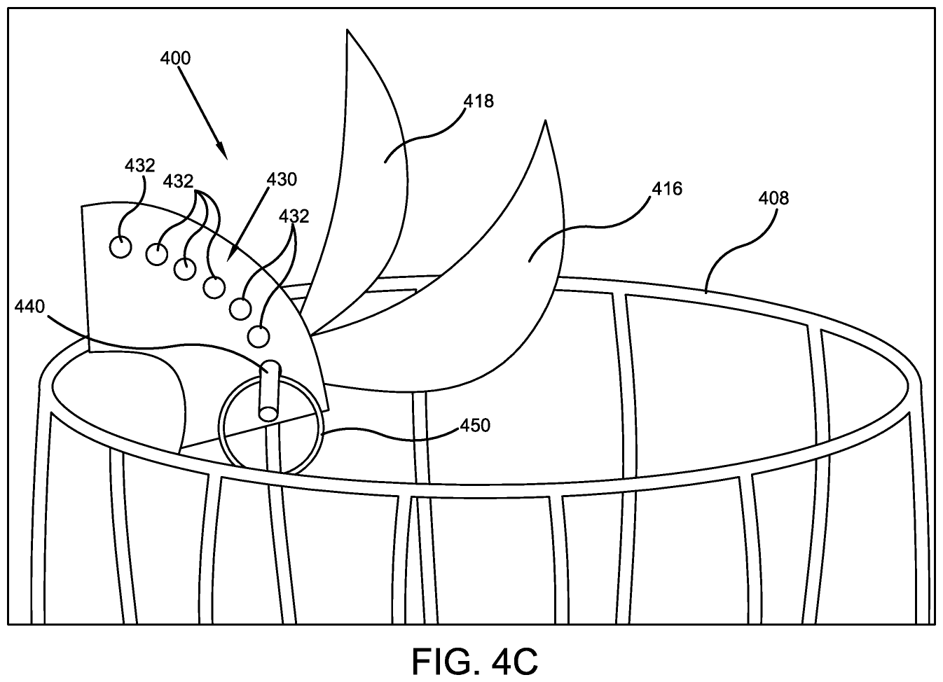

The bottom end 106 of the pole 102 has an ergonomic rubber grip 110 attached thereto that allows a user to easily handle and operate the device 100 for reaching and pruning fruits. The telescoping pole 102 includes a plurality of telescoping sections 112a-n that are configured to extend or retract the length of the device 100 for enabling a user to reach elevated fruits easily. The device 100 provides a power assisted pruning method that involves use of a power button 114 positioned on the pole 102. The power button 114 is internally coupled to a pair of blades 116, 118 positioned on the upper edge 120 of the basket 108 using an internal circuitry 124 via a battery as described in FIG. 3. The power button 114 is configured to be pushed by a user for enabling the blades 116, 118 to periodically, and repeatedly, switch between a closed position as illustrated in FIG. 4A and an open position as illustrated in FIG. 4B for removing fruits. The details of the working of the blades 116, 118 are described in FIG. 3.

For manual operation of the blades 116, 118, a trigger 122 is positioned opposite to the power button 114 on the pole 102 and is coupled to the blades 116, 118 such that when trigger 122 is pushed once, the blades 116, 118 switch from open to closed position and vice versa. The pole 102 can extend up to from about five feet to about twelve feet in one exemplary embodiment, but can extend more in different embodiments of the present invention. The device 100 has a simple structure and is convenient to use. Further, the blades 116, 118 safely removes the fruits from the stems attached to trees/plants wherein the fruits are collected in the basket 108 without requiring users to stretch or climb a ladder.

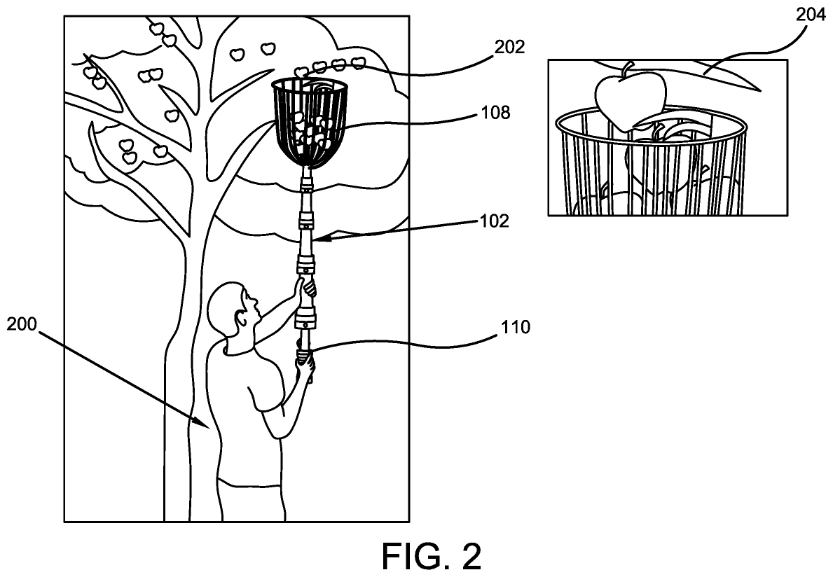

FIG. 2 illustrates a perspective view showing a user using the fruit removing device 100 of the present invention for pruning fruits in accordance with the disclosed architecture. As illustrated, a user 200 extends the pole 102 to a desired length such that the blades 116, 118 reach elevated fruits 202. The device 100 is held by the user using the grip 110 and pole 102 for maintaining balance and providing stability. For removing or collecting the one or more fruits, either the trigger 122 or the power button 114 is pushed by the user as described in FIG. 1 for operating the blades 116, 118. A stem 204 of one or more fruits is positioned between the blades 116, 118 and is cut such that one or more fruits of the branch are removed and collected in the basket 108.

The device 100 can be used until the basket 108 is filled with the fruits and then, the fruits can be removed from the basket 108 easily and conveniently while eliminating dropping of fruits directly on the ground.

FIG. 3 illustrates a functional block diagram showing the operation of the pruning blades 116, 118 of the pruning device of the present invention in accordance with the disclosed architecture. The power button 114 is coupled to an internal battery 302 of the device 100 wherein the battery 302 is configured to provide electric power to the actuate the blades actuator 304. The actuator 304 is coupled to the blades enabling the blades 116, 118 to attain a closed and an open position for removing fruits. The battery 302 can be a rechargeable lithium-ion battery, which can be replaced if required by a user.

The trigger 122 is also coupled directly to the blades actuator 304 via a cable and lever system 306. The cable and lever system 306 actuates the actuator 304 to pull the blades apart to configure the blades in an open position and push the blades to bring the blades 116, 118 in a closed position.

FIG. 4A illustrates an enlarged view of the blades 116, 118 in a closed position for pruning fruits in accordance with the disclosed architecture. As illustrated, the blades 116, 118 touch each other in a closed stated 402 such that any stem of a fruit is positioned between the edges 404, 406 of the blades 116, 118 respectively and is cut by the blades 116, 118 enabling the fruits of the stem to be removed and dropped into the basket 108. It should be appreciated that the blades 116, 118 are positioned inside the basket 108 and along the top edge 120 and thereby do not cause any injury or discomfort to a user.

FIG. 4B illustrates an enlarged view of the blades 116, 118 in an open position in accordance with the disclosed architecture. In the open position, the blades 116, 118 do not touch each other and maintain a gap therebetween such that fruits can easily fall therethrough into the basket 108. The blades 116, 118 are oriented such that fruits stored in the basket 108 are not damaged and the blades 116, 118 are selectively operable using the trigger and/or power button as described in other embodiments of the present invention.

FIG. 4C illustrates an enlarged view of another embodiment of a pruning device 400 with the blades 416, 418 in a partially open position in accordance with the disclosed architecture. The pruning device 400 includes a cutting angle or blade angle adjuster 430 connected to the blades 416, 418 in order to adjust the cutting angle of the blades 416, 418. The adjuster 430 enables the blades 416, 418, selectively, to change angle in order to obtain a desired blade angle to cut a fruit stem from a fruit tree branch. The adjuster 430 includes a plurality of angle adjusting holes 432 for selectively mounting an adjuster pin 440. The pin 440 includes a grasping ring 450 for pulling the pin 440 and selectively rotating the blades 416, 418 and then placing the pin 440 into another hole 432 for securing the blades at another angle relative to the basket 408. The blades 416, 418 are oriented such that fruits stored in the basket 408 are not damaged and the blades 416, 418 are initially selectively angled and then operable using the trigger and/or power button as described in other embodiments of the present invention.

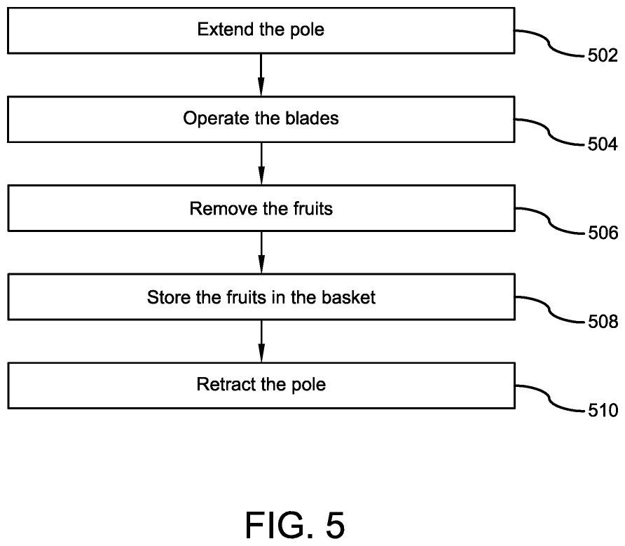

FIG. 5 illustrates a flow diagram illustrating steps performed to use the extendable fruit removing device of the present invention in accordance with the disclosed architecture. Initially, the pole of the device is extended to a desired length using the telescoping means to reach elevated fruits (Step 502). Then, the blades are selectively operated either using the trigger or using the power button (Step 504). Using the blades, one or more fruits are removed from the fruit tree wherein the blades cut the branches or stems of the fruits (Step 506). The removed fruits are stored in the basket and do not drop onto the ground (Step 508). After use, for easy carriage and storage, the pole is retracted to decrease the length of the device (Step 510).

The fruit pruning device 100, 400 can be used with different fruits, vegetables, and all types of trees. The device 100, 400 saves extensive time and effort when manually picking fruit, effectively reducing any strain and muscle fatigue associated with standard methods of fruit picking. In a further embodiment, the device 100, 400 may also comprise a simple pin mechanism that allows the pruning angle to be adjustable to accommodate pruning fruit that is hanging at different angles.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “telescoping fruit pruning basket device”, “fruit removing device”, “pruning device”, “device”, and “extendable fruit removing device” are interchangeable and refer to the telescoping fruit pruning basket device 100, 400 of the present invention.

Notwithstanding the forgoing, the telescoping fruit pruning basket device 100, 400 of the present invention can be of any suitable size and configuration as is known in the art without affecting the overall concept of the invention, provided that it accomplishes the above-stated objectives. One of ordinary skill in the art will appreciate that the telescoping fruit pruning basket device 100, 400 as shown in the FIGS. are for illustrative purposes only, and that many other sizes and shapes of the telescoping fruit pruning basket device 100, 400 are well within the scope of the present disclosure. Although the dimensions of the telescoping fruit pruning basket device 100, 400 are important design parameters for user-convenience, the telescoping fruit pruning basket device 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A telescoping device for removing fruits from trees, the telescoping device comprising:
a pruning device having a telescopic pole with a top end and a bottom end;
a fruit collecting basket attached to said top end;
a plurality of pruner blades proximal to an upper edge of said top end of said basket; and
an actuator for actuating said plurality of pruner blades from an open orientation to a closed orientation;
wherein said actuating said plurality of pruner blades for cutting a stem of the fruit; and
further wherein the fruit drops into said basket after cutting of the stem.

2. The telescoping device for removing fruits of claim 1, wherein said plurality of pruner blades having a pair of blades.

3. The telescoping device for removing fruits of claim 1, wherein said basket having a material selected from a group consisting of a stainless steel and a plastic.

4. The telescoping device for removing fruits of claim 1, wherein said bottom end of said telescopic pole having an ergonomic handle and a trigger proximal to said handle.

5. The telescoping device for removing fruits of claim 1, wherein said telescopic pole having a plurality of telescoping sections for extending and retracting said telescopic pole.

6. The telescoping device for removing fruits of claim 1, wherein said actuator having a power button coupled to a battery for providing electric power to actuate said pair of pruner blades.

7. The telescoping device for removing fruits of claim 6, wherein said pair of pruner blades actuated from an open position to a closed position.

8. The telescoping device for removing fruits of claim 4, wherein said trigger coupled to a cable and lever for manually actuating said pair of pruner blades upon depressing said trigger.

9. The telescoping device for removing fruits of claim 1, wherein said telescopic pole having a plurality of sections to extend said telescopic pole from about five feet to about twelve feet.

10. A telescoping device for removing fruits from trees comprising:
a pruning device having a telescopic pole with a top end and a bottom end;
a fruit collecting basket attached to said top end;
a pair of pruner blades proximal to an upper edge of said top end of said basket;
an actuator for actuating said pair of pruner blades from an open orientation to a closed orientation;
said actuating said pair of pruner blades for cutting a stem of the fruit;
wherein the fruit drops into said basket after cutting of the stem;
wherein said bottom end of said telescopic pole having an ergonomic handle and a trigger proximal to said handle; and
further wherein said pair of pruner blades selectively actuated from an open position to a closed position.

11. The telescoping device for removing fruits of claim 10, wherein said trigger coupled to a cable and lever for manually actuating said pair of pruner blades upon depressing said trigger.

12. The telescoping device for removing fruits of claim 10, wherein said telescopic pole having a plurality of telescoping sections for extending and retracting said telescopic pole.

13. The telescoping device for removing fruits of claim 10, wherein said actuator having a power button coupled to a battery for providing electric power to actuate said pair of pruner blades.

14. The telescoping device for removing fruits of claim 10, wherein said telescopic pole having a plurality of sections to extend said telescopic pole from about five feet to about twelve feet.

15. A method of using a telescoping pruning device for removing fruits from trees comprising the steps of:
adjusting an angle of a pair of pruner blades relative to an upper edge of a fruit collecting basket of a pruning device;
extending a telescopic pole of said pruning device having a top end and a bottom end;
placing said fruit collecting basket attached to said top end under the fruit;
actuating said pair of pruner blades proximal to said upper edge of said top end of said fruit collecting basket;
moving said pair of pruner blades selectively from an open orientation to a closed orientation;
cutting a stem of the fruit; and
dropping the fruit into said fruit collecting basket.

16. The method of claim 15, wherein said bottom end of said telescopic pole having an ergonomic handle and a trigger proximal to said handle.

17. The method of claim 16, wherein said trigger coupled to a cable and lever for manually actuating said pair of pruner blades upon depressing said trigger.

18. The method of claim 17, wherein said telescopic pole having a plurality of telescoping sections for extending and retracting said telescopic pole.

19. The method of claim 15 further comprising a step of pressing a power button coupled to a battery for providing electric power for actuating said pair of pruner blades.

20. The method of claim 19, wherein said telescopic pole having a plurality of sections to extend said telescopic pole from about five-feet to about twelve-feet.
